(19) United States
(12) Patent Application Publication
(10) Pub. No.: US 2013/0082940 A1
(43) Pub. Date: Apr. 4, 2013

(54) DEVICE WITH CUSTOMIZABLE CONTROLS

(71) Applicants: Alexander Brian MAINWARING, Waterloo (CA); Tyler Lee WILLIAMS, Waterloo (CA); Jamieson Robin PEPPER, Waterloo (CA)

(72) Inventors: Alexander Brian MAINWARING, Waterloo (CA); Tyler Lee WILLIAMS, Waterloo (CA); Jamieson Robin PEPPER, Waterloo (CA)

(73) Assignee: RESEARCH IN MOTION LIMITED, Waterloo (CA)

(21) Appl. No.: 13/252,347

(22) Filed: Oct. 4, 2011

(51) Int. Cl. G06F 3/041

(52) U.S. Cl. 345/173

(57) ABSTRACT

A method and device for receiving input for a computer application are provided. The method involves receiving, at a touchscreen device including a touchscreen, input indicative of populating a subset from a set of given input elements. The subset is for providing application input data to a computer application. The subset is displayable on the touchscreen. The method further involves rendering the subset on the touchscreen such that the subset is operably configured to receive the application input data. The device includes a processor and touchscreen configured to carry out the method.

### BACKGROUND OF THE INVENTION

1. Field of Invention

The present invention relates generally to touchscreen devices, and more particularly to a touchscreen device with customizable controls and method therefor.

2. Description of Related Art

The evolution of computers is currently quite active in the mobile device environment. It is now well-known to implement a touchscreen as an input device as part of portable electronic devices. Indeed, there has been a veritable explosion of the number and type of devices implementing touchscreens that are configured to execute various applications on portable electronic devices and other computing environments.

### BRIEF DESCRIPTION OF THE DRAWINGS

In drawings which illustrate implementations of the invention,

FIG. 1 is a front view of a touchscreen device with customizable controls, according to non-limiting implementations;

FIG. 2 is a schematic block diagram of the touchscreen device shown in FIG. 1;

FIG. 3 is a front view of the touchscreen device shown in FIG. 1, with a screen shot of a virtual keyboard;

FIG. 4 is a front view of the touchscreen device shown in FIG. 1 with a screen shot of a plurality of virtual keys;

FIG. 5 is a front view of the touchscreen device shown in FIG. 1 with a screen shot of a plurality of virtual keys of different sizes and shapes;

FIG. 6 is a block diagram of a method for customizing controls at the touchscreen device of FIG. 1;

FIG. 7 is a front view of the touchscreen device shown in FIG. 1 with a screen shot of a display area showing drag-and-drop function; and

FIG. 8 is a front view of the touchscreen device shown in FIG. 1 with a screen shot of a display area showing a list for selection; and

FIG. 9 is a front view of the touchscreen device shown in FIG. 1 with a screen shot of a display area; and

FIG. 10 is a block diagram of a method for rendering input elements at the touchscreen device of FIG. 1.

### DETAILED DESCRIPTION

In accordance with another aspect of the invention, there is provided a touchscreen device. The touchscreen device includes a processor and a touchscreen. The processor is operably configured to receive input indicative of populating a subset from a set of given input elements. The subset is for providing application input data to a computer application. The subset is displayable on the touchscreen. The processor is further operably configured to render the subset on the touchscreen such that the subset is operably configured to receive the application input data.

The processor may be operably configured to receive further input indicative of a selection of a display area. The display area is for rendering output from the computer application. The display area is smaller than the touchscreen.

The processor may be operably configured to scale the output such that the output is completely rendered within the display area.

The processor may be operably configured to receive further input indicative of a selection of a location on the touchscreen such that a selected input element of the subset is rendered at the location.

The processor may be operably configured to receive input indicative of populating the subset may be further operably configured to receive data indicative of a selection from a list.

The set of given input elements may include virtual keyboard keys rendered at the touchscreen.

In accordance with an aspect of the invention, there is provided a method involving receiving, at a touchscreen device including a touchscreen, input indicative of populating a subset from a set of given input elements. The subset is for providing application input data to a computer application. The subset is displayable on the touchscreen. The method further involves rendering the subset on the touchscreen such that the subset is operably configured to receive the application input data.

The method may involve receiving further input indicative of a selection of a display area. The display area is for rendering output from the computer application. The display area is smaller than the touchscreen.

The method may also involve scaling the output such that the output is rendered within the display area.

Rendering the subset of the input elements on the touchscreen may involve rendering the subset of the input elements outside the display area.

The method may additionally involve receiving further input indicative of a selection of a location on the touchscreen such that a selected input element of the subset is rendered at the location.

The input indicative of populating the subset may include data indicative of a drag-and-drop selection on the touchscreen.

Receiving the input indicative of populating the subset may involve receiving data indicative of a selection from a list.

The list may include input elements of the set of given input elements.

The list may include combinations of the input elements of the set of given input elements.

Receiving the input indicative of populating the subset may involve receiving data from an input device other than the touchscreen.

The set of given input elements may include virtual keyboard keys rendered at the touchscreen.

The method may further involve downloading the computer application into a memory of the touchscreen device through a network connection.

The method may also involve executing the computer application on the touchscreen device.

In accordance with yet another aspect of the invention there is provided a touchscreen device. The touchscreen device includes a touchscreen and a processor. The touchscreen device further includes means for receiving input indicative of populating a subset from a set of given input elements. The subset is for providing application input data to a computer application. The subset is displayable on the touchscreen. The touchscreen device also includes means for rendering the subset on the touchscreen such that the subset is operably configured to receive the application input data.

In accordance with yet another aspect of the invention there is provided a non-transitory computer readable medium encoded with codes. The codes are for directing a processor to receive input indicative of populating a subset from a set of given input elements. The subset is for providing application input data to a computer application. The subset is displayable on the touchscreen. The codes are also for directing a processor to render the subset on the touchscreen such that the subset is operably configured to receive the application input data.

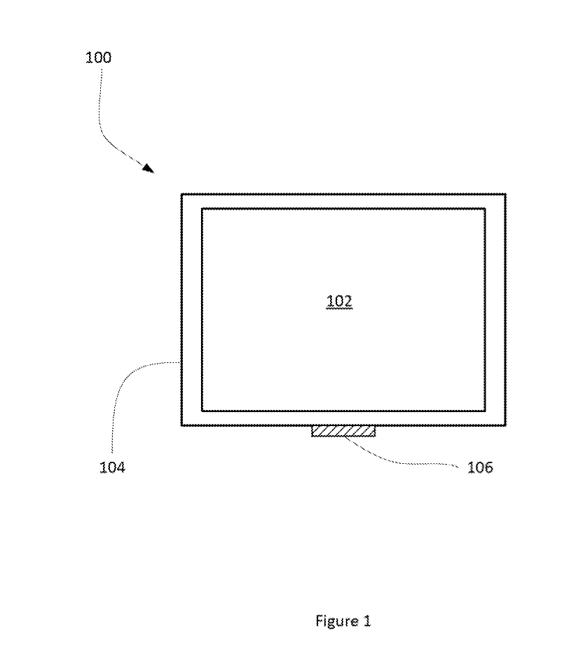

Referring to FIG. 1, a touchscreen device according to an implementation for providing customizable controls is shown generally at 100. The device 100 includes a touchscreen 102 and a body 104. The touchscreen device 100 also includes a connector 106 for connecting the touchscreen device 100 to another device (not shown). The other device may include a computer, an input device, an output device or another touchscreen device 100.

In this implementation, some examples of touchscreen technologies that are suitable for the touchscreen 102 of the touchscreen device 100 are resistive system touchscreens, capacitive system touchscreens and surface acoustic wave system touchscreens. In addition, other touchscreen technologies may be used with the touchscreen device 100. In other implementations still, alternative means by which input may be received over a screen can be suitably.

In this implementation, the body 104 is a durable lightweight material. The material should be lightweight so that the touchscreen device 100 is light and easy to carry, making the device more portable. The material should also be durable to protect the internal components of the touchscreen device 100. For example, a suitable material to use for the body is plastic. In particular, Polycarbonate/Acrylonitrile Butadiene Styrene blends may be particularly suitable for the body 104. In other implementations, other materials such as metal and metal alloys with suitable characteristics for an electronic device may be used.

The touchscreen device 100 includes a battery (not shown) to power the device. In the implementation shown, the connector 106 is primarily for supplying power to charge the battery in the touchscreen device 100 when connected to a power source. The connector 106 may also be used to connect the touchscreen device 100 to another device for data sharing. For example, the touchscreen device 100 may be connected to a personal computer through the connector 106 in order to download programs onto the device. Therefore, the connector 106 may be a standard USB™ connector; however, any other type of connector capable of charging the touchscreen device 100 or providing data sharing capabilities would be suitable. In other implementations, it will be appreciated that if a touchscreen device 100 was equipped with replaceable batteries or inductive charging technology, no connector would be required.

The touchscreen device 100 can be any type of touchscreen device that can be used in a self-contained manner. The touchscreen device 100 is enabled to perform various functions which include rendering information on the touchscreen 102. In addition, the touchscreen device 100 is also enabled to receive input from the touchscreen 102.

In the present implementation, the touchscreen device 100 comprises a tablet computing device. However, it will be appreciated that other implementations may comprise other types of touchscreen devices with a touchscreen, such as smart phones or personal gaming consoles. Furthermore, other implementations may even comprise a laptop computer, or a monitor set with a touchscreen interface.

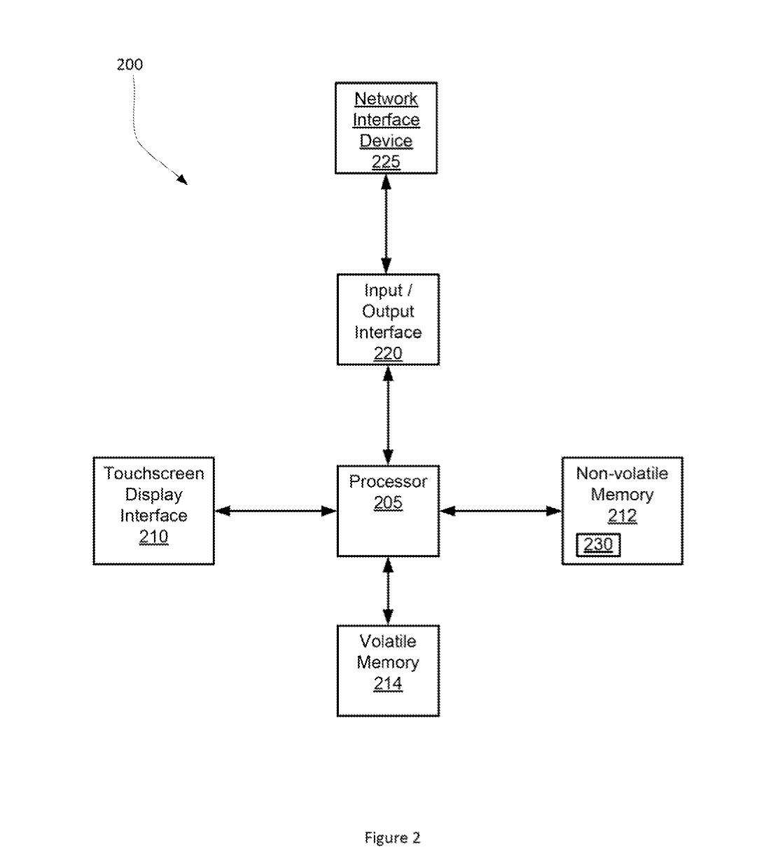

Referring to FIG. 2, a schematic block diagram of components of touchscreen device 100 is shown generally at 200. In this implementation, the touchscreen device 100 includes a processor 205, a touchscreen display interface 210, a non-volatile memory 212, a volatile memory 214, and an input/output interface 220 all in communication with the processor 205. It should be emphasized that the structure in FIG. 2 is purely exemplary, and contemplates a touchscreen device 100 that can be used for both wireless voice (e.g. telephony) and wireless data (e.g. email, web browsing, text) communications.

The touchscreen display interface 210 is in communication with the processor 205 and the touchscreen 102. Processor 205 is configured to communicate with non-volatile memory 212 and volatile memory 214 as needed during operation. Examples of non-volatile memory 212 include any type of non-transitory computer readable medium, Erasable Electronic Programmable Read Only Memory (“EEPROM”), Flash Memory, and as well as any other type of memory where the contents of the memory are preserved if the memory is powered off. Examples of volatile memory include random access memory (“RAM”) as well as any other type of memory where the contents are lost once the memory is powered off. Programming instructions that implement the functional teachings of the touchscreen device 100 as described herein are typically maintained, persistently, in non-volatile memory 212 and used by processor 205 which makes appropriate utilization of volatile memory 214 during the execution of such programming instructions. Those skilled in the art will now recognize that non-volatile memory 212 and volatile memory 214 are examples of computer readable media that can store programming instructions executable on processor 205. In particular, non-volatile memory 212 can store a computer application 230, which can be processed by processor 205. Examples of applications include games, educational programs, map applications, e-readers, and any other type of applications typically available for a touchscreen device.

In the present implementation, the Input/Output interface 220 is in communication with the processor 205 and a network interface device 225. The network interface device 225 connects the touchscreen device 100 to a network for downloading the computer application 230 through the network into the non-volatile memory 212. Therefore, the network interface device 225 may be in communication with the connector 106. Alternatively, the network interface device 225 may also be connected to a network wirelessly using technologies such as Wi-Fi™, Bluetooth™, and cellular networks.

In other implementations, a user input/output interface may connect a processor to other devices such as a display device (eg. cathode ray tube, liquid crystal display, plasma display, organic light emitting diode), speakers, microphones, buttons or keys on a touchscreen device, an external keyboard or a pointer device. It will be appreciated that other devices capable of generating output based on data received from the processor or other devices capable of sending data to the processor based on input at the device may also be connect to the input/output interface. Furthermore, it will be appreciated that in some implementations, the input/output interface will be capable of handling data from several devices, all of which are in communication with the processor. In addition, it is also contemplated that a touchscreen device may include a plurality of processors instead of a single processor.

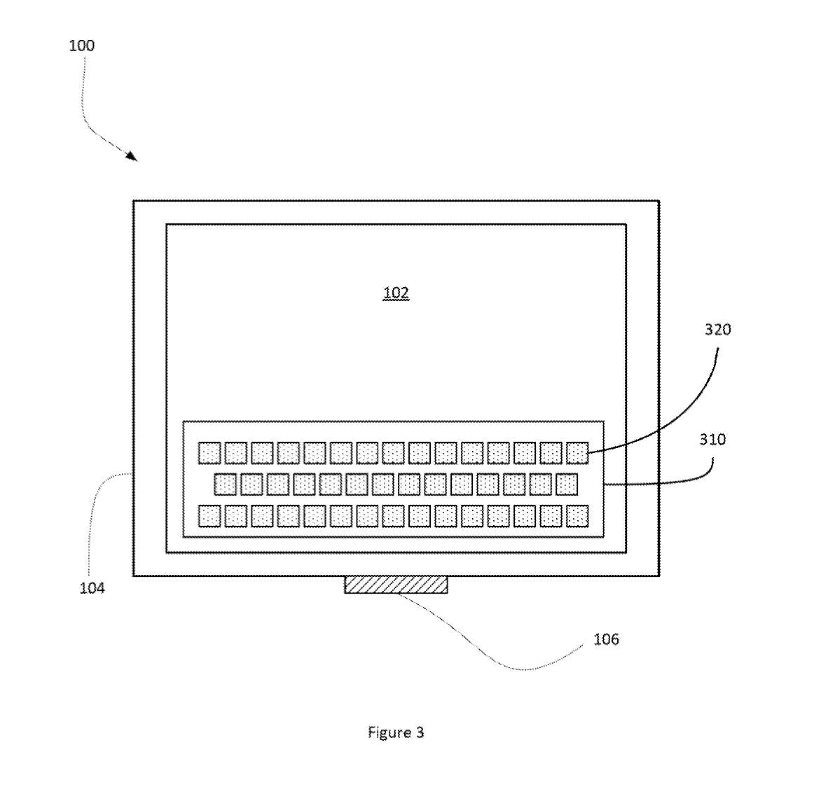

Referring to FIG. 3, the touchscreen device 100 is shown with a virtual keyboard 310 rendered on the touchscreen 102. In the present implementation, the virtual keyboard 310 provides a set of given input elements where each input element is represented by a virtual key 320. Each virtual key 320 is configured to receive input on the touchscreen through any suitable touchscreen mechanisms. The input from the touchscreen is then communicated via the touchscreen display interface 210 to the processor 205.

In the present implementation, the virtual keyboard 310 may include a layout similar to one that is normally on a physical keyboard. It will be appreciated that the specific layout of a physical keyboard varies depending on the country where the keyboard is intended to be used. Furthermore, the virtual keyboard 310 may be compressed or otherwise slightly modified to allow it to fit on the touchscreen 102. During operation of the touchscreen device 100, the virtual keyboard 310 may appear on the touchscreen 102 when an application requests keyboard input. During periods where no keyboard input is requested, the virtual keyboard 310 may be hidden so that the keyboard does not obstruct the output rendered to the touchscreen 102. Hiding of the virtual keyboard 310 may be initiated when an application no longer requires any input to be received from the touchscreen. In addition, the virtual keyboard may also be hidden after an automatic time-out indication is generated after a determined period of inactivity at the touchscreen 102.

In other implementations, a touchscreen device may allow for the use of a physical keyboard connected to the device through the connector. The physical keyboard may be directly connected to the connector, or it may be connected through a docking station. In yet another implementation, another type of touchscreen device may also include a physical keyboard permanently attached to the touchscreen device, for example as in a laptop. In both of these cases, the physical keyboard would provide a set of given input elements to a processor.

Although the only devices described to provide a set of given input elements have been a physical keyboard or a virtual keyboard, it should be appreciated that other methods of inputs as well as other input devices may be used to provide the set of given input elements. For example, other types of input devices capable of providing a set of given input elements are joysticks, video game controllers, pointer devices, and touchscreens without a virtual keyboard.

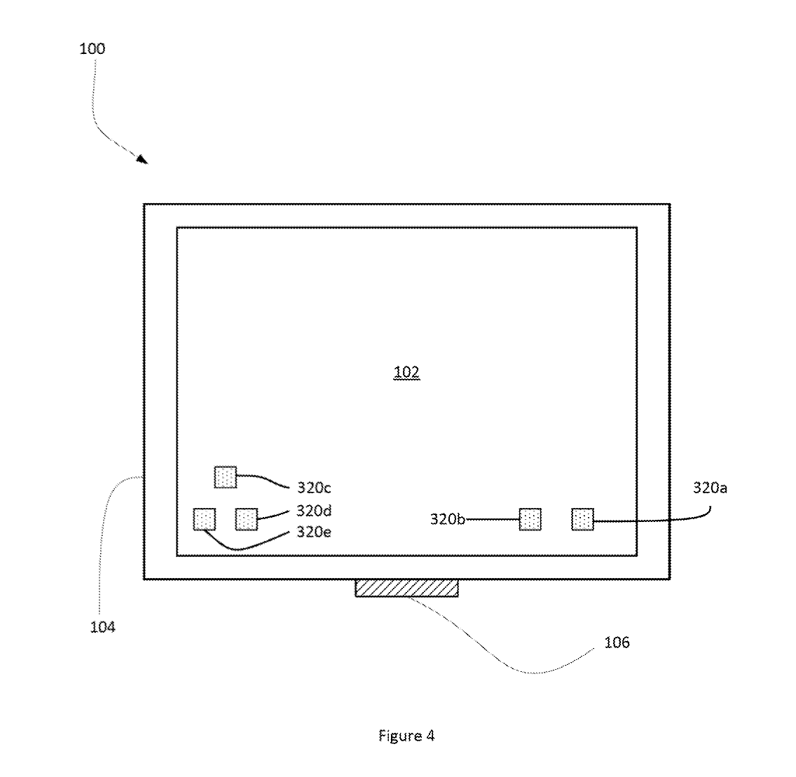

Referring to FIG. 4, the touchscreen device 100 is shown with a subset of input elements rendered at touchscreen 102. As shown in the present implementation, the subset of input elements is a plurality of virtual keys 320a-e. The plurality of virtual keys 320a-e is configured to receive data corresponding to application input data requested during execution of the computer application 230. Application input data includes input data that the computer application 230 may frequently request while it is running. For example, if the computer application 230 is a video game requiring input data corresponding to the arrow keys of a keyboard, the application input data would be data corresponding to the arrow keys of a keyboard. In contrast to the keyboard 310 which may be hidden after a determined period of inactivity at the touchscreen 102, the plurality of virtual keys 320a-e will remain on the touchscreen as long as the computer application 230 is running.

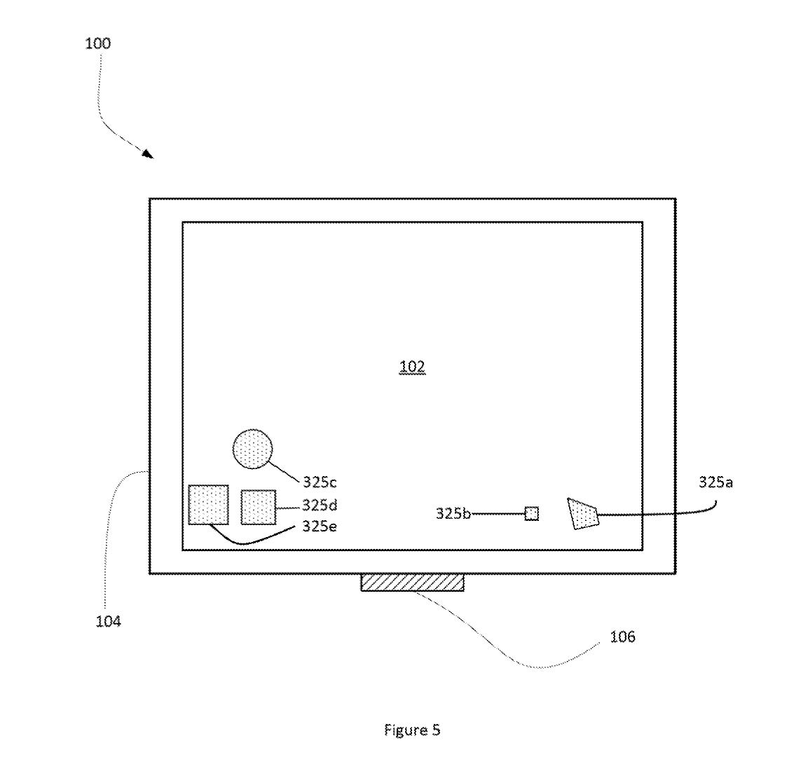

Referring to FIG. 5, the touchscreen device 100 is shown with a subset of input elements rendered at touchscreen 102 in accordance with another implementation. As shown in the present implementation, the subset of input elements is a plurality of virtual keys 325a-e. The plurality of virtual keys 325a-e is similar to the plurality of virtual keys 320a-e discussed above in connection with FIG. 4 and each virtual keys 325a-e may correspond to each of the virtual keys 320a-e respectively. The plurality of virtual keys 325a-e is configured to receive data corresponding to application input data requested during execution of the computer application 230. In contrast to merely rendering, the virtual keys 320a-e as they would have appeared in the virtual keyboard 310, the processor 205 has changed the size and shape of the virtual keys 320a-e into various sizes and shapes of the virtual keys 325a-e. For example, once virtual keys 320a-3 are selected and/or populates, further input can be received at touchscreen device 102, the further input indicative that a shape and/or size virtual keys 320a-e are to be changes, resulting in virtual keys 325a-e. Any suitable method can be used to indicate that a change in shape and/or size of virtual keys 320a-e are to occur, including but not limited to choosing new shapes and/or sizes from a menu, touchscreen input, input indicative that a shape of a given side of a given virtual key 320a-e is to be changes, and the like.

It is appreciated from FIG. 5 that virtual keys 325a and 325c are rendered as an irregular polygon and circle respectively, for example. Further, virtual keys 325d and 325e are rendered in a larger size than the corresponding virtual keys 320d and 320e and virtual key 325b is rendered in a smaller size than the corresponding virtual keys 320b. However, it is appreciated that shapes are not limited to squares, irregular, polygons and circles, and that any suitable shape and/or change in shape is within the scope of present implementations. Furthermore, a given virtual key 320a-3 can undergo any suitable combination of a change in shape and a change in size, which can be performed in any suitable order.

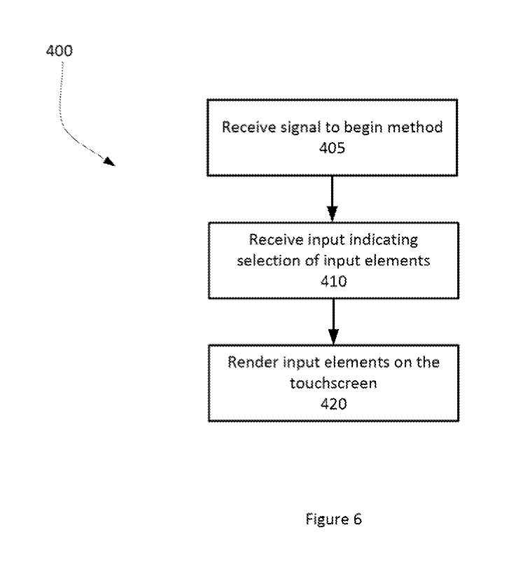

Referring to FIG. 6, a flowchart representing method for rendering customizable controls is shown generally at 400. In order to assist in the explanation of method 400, it will be assumed that method 400 is performed using the touchscreen device 100. Furthermore, the following discussion of method 400 will lead to a further understanding of touchscreen device 100 and its various components. However, it is to be understood that touchscreen device 100 and/or method 400 can be varied, and need not work exactly as discussed herein in conjunction with each other, and that such variations are within the scope of present implementations. It is appreciated that in the following description, method 400 is implemented in touchscreen device 100 by processor 205. Furthermore, in this particular implementation, the blocks generally represent codes read from the non-volatile memory 212, for directing the processor 205 to manage input received from a user for the purpose of rendering input elements on the touchscreen 102. The actual code to implement each block may be written in any suitable programming language, such as Flash™, Java, Delphi®, C, and/or C++.

The method 400 begins at 405 when a request is received at the processor 205 to begin the method. This request can be received from the touchscreen 102 through the touchscreen display interface 210 as a result of input at the touchscreen. It will be appreciated that other types of input, such as a short-cut key on the touchscreen device 100 or input from another input device connected to the input/output interface 220, may generate the request. Alternatively, the request may be generated internally by the computer application 230 while the application is being executed or automatically under predetermined conditions. It will be further appreciated that the origin of the request may be anything as long as the request triggers the processor 205 to begin method 400.

At block 410, the processor 205 receives input indicating a selection and/or a populating of a subset of input elements. For example, after receiving the input, the processor 205 can populate the subset of input elements with the selected input elements. However, in other implementations, the processor 205 populates the subset of input elements when receiving the input. In the present implementation, the subset of input elements is the plurality of virtual keys 320a-e displayable on the touchscreen 102. Furthermore, the plurality of virtual keys 320a-e selected from the virtual keyboard 310 such that computer application 230 would generally only request application input data from the plurality of virtual keys 320a-e. Therefore, virtual keys of the virtual keyboard 310, which are not part of the plurality of virtual keys 320a-e, are generally not requested for input when executing the computer application 230. It will be appreciated that the plurality of virtual keys is not limited to exactly five virtual keys and that the subset may include more or less virtual keys depending on the requirements of the computer application 230.

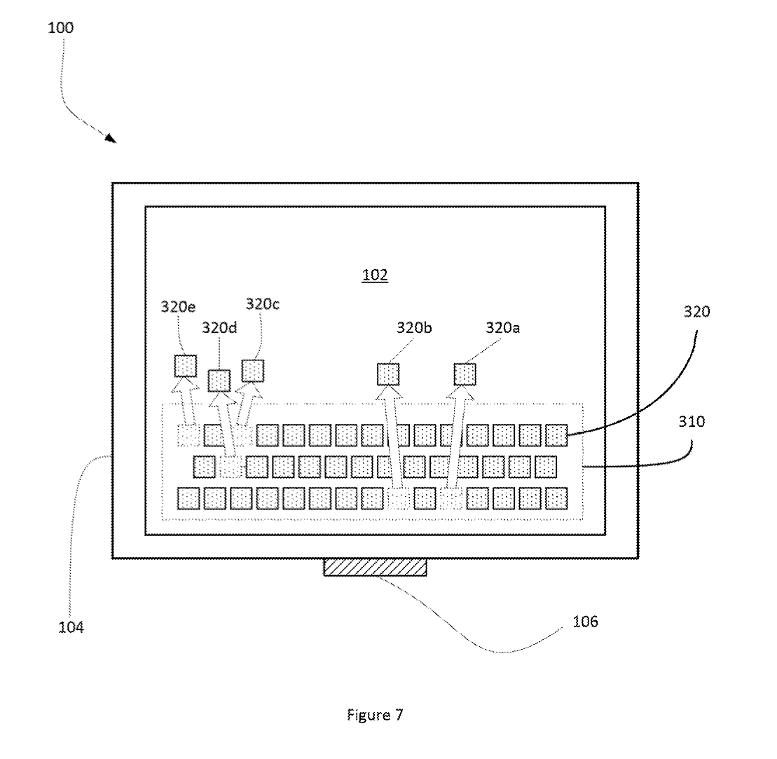

The input indicating a selection of the plurality of virtual keys 320a-e in the method 400 may include data of various types. For example, referring to FIG. 7, one implementation of the input indicating a selection of the plurality of virtual keys 320a-e may involve code directing the processor 205 to receive data indicative of a drag-and-drop selection process on the touchscreen 102. This data may result from dragging a virtual key from the virtual keyboard 310 to a location off of the virtual keyboard to indicate the selection of the plurality of virtual keys 320a-e, as represented by the arrows in FIG. 7. In the implementation shown, the plurality of virtual keys 320a-e will automatically be repositioned as shown in FIG. 4. In other implementations, the plurality of virtual keys 320a-e may be positioned at a location where the virtual key was “dropped”. Furthermore, although this implementation renders the virtual keys in the format of the virtual keyboard 310, it is contemplated that in other implementations that the virtual keys may be rendered on the touchscreen 102 in a format other than a virtual keyboard where the same drag-and-drop selection method can be used.

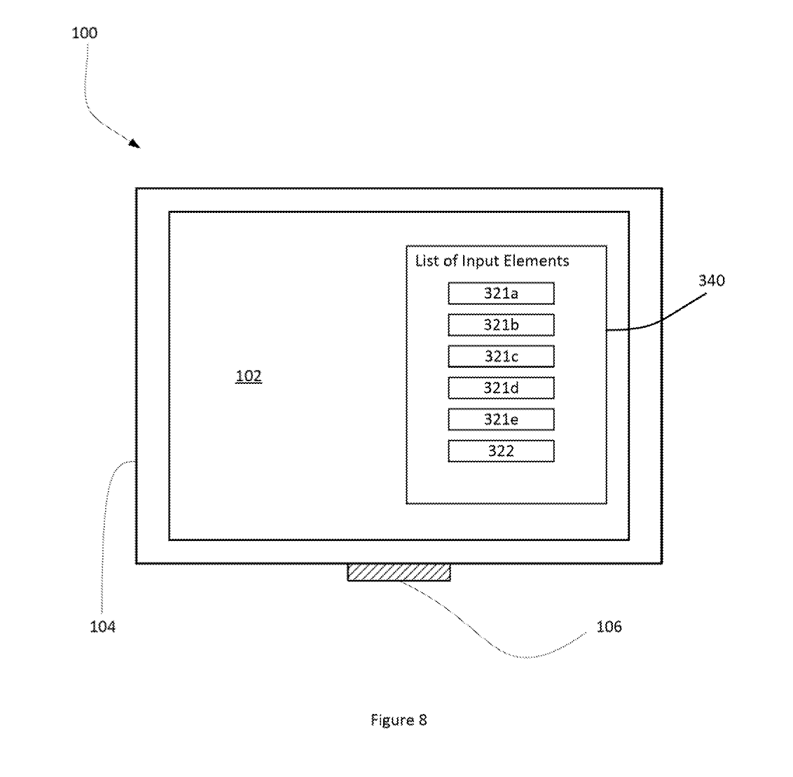

In another example shown in FIG. 8, the processor 205 may be directed to receive data indicative of a selection from a list 340 rendered on the touchscreen 102. It is contemplated that in other implementations, a list may be entirely separate from the touchscreen device 100, such as in a manual. The data indicative of a selection from the list 340 may also be received from any input device capable of providing input to the processor 205 including the touchscreen 102. In the present implementation, the list 340 is presented on the touchscreen 102 and includes list items 321a-e, and 322 where list items 321a-e correspond to virtual keys 320a-e respectively. When the processor 205 receives data indicative of each of the list items 321a-e, the processor will render each of the plurality of virtual keys 320a-e respectively. The list 340 may also include list items corresponding to pre-determined combinations of the virtual keys of the virtual keyboard 310, such as keys used for the computer application 230. In the present implementation, list item 322 corresponds to the combination comprising the plurality of virtual keys 320a-e. Therefore, when the processor 205 receives data indicative of list item 322, the processor will render the plurality of virtual keys 320a-e respectively. By providing combinations of virtual keys, the selection process is more efficient compared with selecting individual virtual keys. It will be appreciated that in other implementations where the set of given input elements is something other than a virtual keyboard, the list may include the input elements of the set of given input elements and combinations of the input elements of the set of given input elements.

In other implementations of a touchscreen device with a processor for carrying out method 400 where the set of given input elements is not a virtual keyboard, it should be noted that the subset of input elements are still displayable on the touchscreen of the touchscreen device. Furthermore, as discussed above, the set of given input elements need not be limited to correspond to keys of a keyboard. For example, receiving input indicating a selection of the plurality of virtual keys 320a-e may involve receiving data from an input device other than the touchscreen 102. Examples of input devices other than the touchscreen include an external keyboard, a joystick, a video game controller, or a mouse.

In instances where a plurality of virtual keys includes an input element that does not correspond to a key of a keyboard, a virtual key is still generated to represent the input of the input element. For example, if an input element corresponds to moving a joystick up, where the set of given input elements includes all possible input from a joystick, the subset of input elements would include a virtual key displayable on a touchscreen for receiving input corresponding to moving the joystick up.

When the processor 205 receives input indicating a selection of a subset of input elements as described in block 410, the processor 205 may further receive input indicative of a selection of a plurality of locations on the touchscreen 102 where the plurality of virtual keys 320a-e are to be rendered. The input indicative of a selection of a plurality of locations on the touchscreen 102 where the plurality of virtual keys 320a-e are to be rendered can be received through the touchscreen display interface 210 as a result of input at the touchscreen 102. For example, the drag-and-drop selection process described above can indicate the plurality of locations for the plurality of virtual keys 320a-e by using the “drop” location. It will be appreciated that other types of input, such from another input device connected to the input/output interface 220, may receive input indicative of a selection of a plurality of locations. Alternatively, the input indicative of a selection of a plurality of locations may be generated internally by the computer application 230. For example, the computer application 230 may have a pre-determined list of locations for the plurality of virtual keys 320a-e which is automatically applied during method 400.

At block 420, the processor 205 renders the plurality of virtual keys 320a-e on the touchscreen 102. In this implementation, the plurality of virtual keys 320a-e are enabled to receive input at the touchscreen 102 corresponding to the application input data for the computer application 230 executed by the processor 205. Again, it will be appreciated that the plurality of virtual keys is not limited to exactly five virtual keys and that the subset may include more or less virtual keys depending on the requirements of the computer application 230.

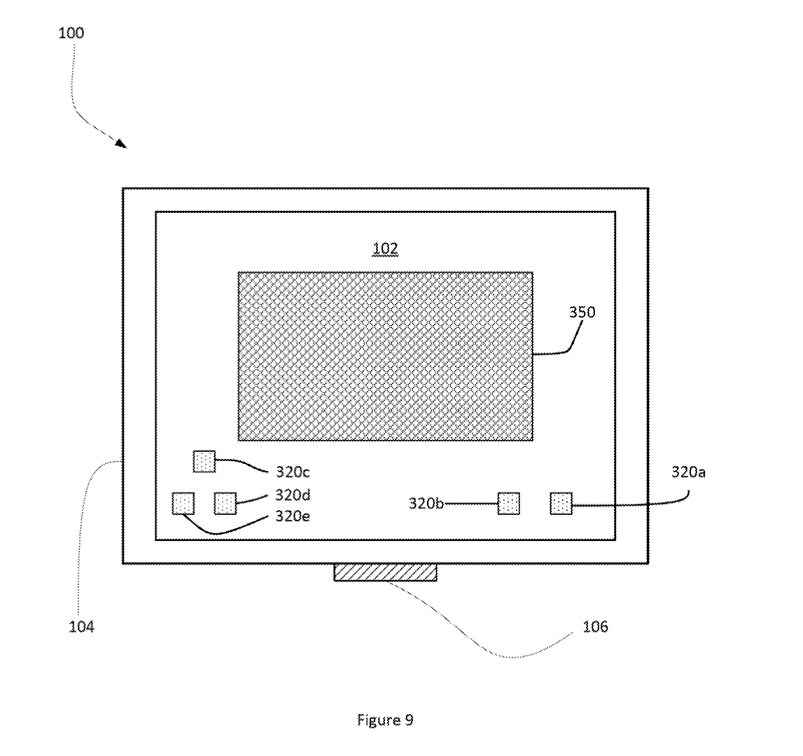

Referring to FIG. 9, the touchscreen device 100 is shown with a subset of input elements. As shown in this implementation, the subset of input elements is a plurality of virtual keys 320a-e, which is identical to the plurality of virtual keys shown in FIG. 4. The plurality of virtual keys 320a-e is configured to receive data corresponding to application input data requested during execution of the computer application 230. Application input data includes input data that the computer application 230 may frequently request while it is running. For example, if the computer application 230 is a video game requiring input data corresponding to the arrow keys of a keyboard, the application input data would be data corresponding to the arrow keys of a keyboard. In contrast to the keyboard 310 which may be hidden after a determined period of inactivity at the touchscreen 102, the plurality of virtual keys 320a-e will remain on the touchscreen as long as the computer application 230 is running. In the present implementation, the touchscreen device 100 includes, a display area 350 is shown. The display area 350 is a portion of the touchscreen 102 for rendering output from the computer application 230. Therefore, it will be appreciated that the remaining area of the touchscreen 102 will not be available for rendering output from the computer application 230. Although the display area 350 is shown to be smaller than the full size of the touchscreen 102 in the present implementation, it should be appreciated that a display area can be equal to the full size of the touchscreen 102. It will also be recognized that the plurality of virtual keys 320a-e may be rendered within the display area 350 such that a virtual key may overlap a small portion of the output from the computer application 230.

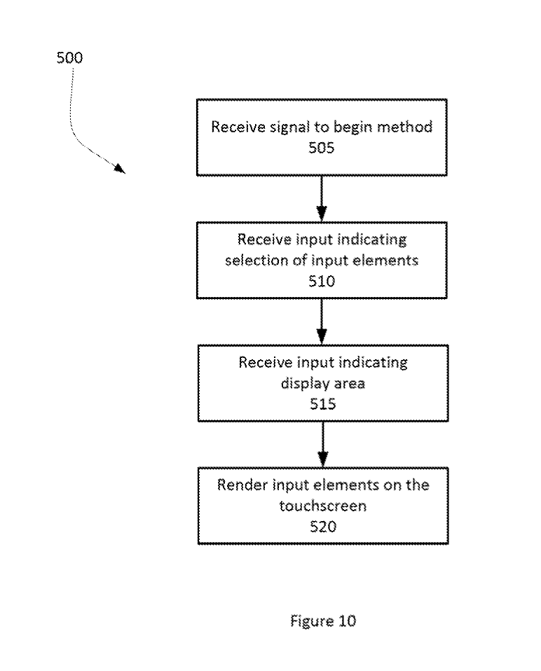

Referring to FIG. 10, a flowchart representing method for rendering customizable controls is shown generally at 500. In order to assist in the explanation of method 500, it will be assumed that method 500 is performed using the touchscreen device 100. Furthermore, the following discussion of method 500 will lead to a further understanding of touchscreen device 100 and its various components. However, it is to be understood that touchscreen device 100 and/or method 500 can be varied, and need not work exactly as discussed herein in conjunction with each other, and that such variations are within the scope of present implementations. It is appreciated that in the following description, method 500 is implemented in touchscreen device 100 by processor 205. Furthermore, in this particular implementation, the blocks generally represent codes read from the non-volatile memory 212, for directing the processor 205 to manage input received from a user for the purpose of rendering input elements on the touchscreen 102. The actual code to implement each block may be written in any suitable programming language, such as Flash™, Java, Delphi®, C, and/or C++.

The method 500 begins at 505 when a request is received at the processor 205 to begin the method. This request can be received from the touchscreen 102 through the touchscreen display interface 210 as a result of input at the touchscreen. It will be appreciated that other types of input, such as a short cut key on the touchscreen device 100 or input from another input device connected to the input/output interface 220, may generate the request. Alternatively, the request may be generated internally by the computer application 230 while the application is being executed or automatically under predetermined conditions. It will be further appreciated that the origin of the request may be suitable origin such that the request triggers the processor 205 to begin method 500.

At block 510 processor 205 receives input indicating a selection and/or populating of a subset of input elements. For example, after receiving the input, the processor 205 can populate the subset of input elements with the selected input elements. However, in other implementations, the processor 205 populates the subset of input elements when receiving the input. In the present implementation, the subset of input elements is the plurality of virtual keys 320a-e displayable on the touchscreen 102. Furthermore, the plurality of virtual keys 320a-e are selected from the virtual keyboard 310 such that computer application 230 would generally only request application input data from the plurality of virtual keys 320a-e. Therefore, virtual keys of the virtual keyboard 310, which are not part of the plurality of virtual keys 320a-e, are generally not requested for input when executing the computer application 230. It will be appreciated that the plurality of virtual keys is not limited to exactly five virtual keys and that the subset may include more or less virtual keys depending on the requirements of the computer application 230.

The input indicating a selection of the plurality of virtual keys 320a-e in the method 500 may include data of various types. For example, referring back to FIG. 7, one implementation of the input indicating a selection of the plurality of virtual keys 320a-e may involve code directing the processor 205 to receive data indicative of a drag-and-drop selection process on the touchscreen 102. This data may result from dragging a virtual key from the virtual keyboard 310 to a location off of the virtual keyboard to indicate the selection of the plurality of virtual keys 320a-e. In the implementation shown, the plurality of virtual keys 320a-e will automatically be repositioned as shown in FIG. 4. In other implementations, the plurality of virtual keys 320a-e may be positioned at a location where the virtual key was “dropped”. Furthermore, although this implementation renders the virtual keys in the format of the virtual keyboard 310, it is contemplated that in other implementations that the virtual keys may be rendered on the touchscreen 102 in a format other than a virtual keyboard where the same drag-and-drop selection method can be used.

Referring back to FIG. 8, another implementation for the selection of the plurality of virtual keys 320a-e in the method 500 can also be applied. The processor 205 can receive data indicative of a selection from a list 340 rendered on the touchscreen 102. It is contemplated that in other implementations, a list may be entirely separate from the touchscreen device 100, such as in a manual. The data indicative of a selection from the list 340 may also be received from any input device capable of providing input to the processor 205 including the touchscreen 102. In the present implementation, the list 340 is presented on the touchscreen 102 and includes list items 321a-e, and 322 where list items 321a-e correspond to virtual keys 320a-e respectively. When the processor 205 receives data indicative of each of the list items 321a-e, the processor will render each of the plurality of virtual keys 320a-e respectively. The list 340 may also include list items corresponding to pre-determined combinations of the virtual keys of the virtual keyboard 310, such as keys used for the computer application 230. In the present implementation, list item 322 corresponds to the combination comprising the plurality of virtual keys 320a-e. Therefore, when the processor 205 receives data indicative of list item 322, the processor will render the plurality of virtual keys 320a-e respectively. By providing combinations of virtual keys, the selection process is more efficient compared with selecting individual virtual keys. It will be appreciated that in other implementations where the set of given input elements is something other than a virtual keyboard, the list may include the input elements of the set of given input elements and combinations of the input elements of the set of given input elements.

In another example, the processor 205 receives data indicative of a selection from a list. The list may be rendered on the touchscreen 102 or the list may be entirely separate from the touchscreen device 100, such as in a manual. The data indicative of a selection from a list may also be received from any input device capable of providing input to the processor 205 including the touchscreen 102. In the present implementation, the list may be a list presented on the touchscreen of all the virtual keys of the virtual keyboard 310. The list may also include pre-determined combinations of the virtual keys of the virtual keyboard 310, such as keys used for the computer application 230. By providing combinations of virtual keys, the selection process is more efficient compared with selecting individual virtual keys. It will be appreciated that in other implementations where the set of given input elements is something other than a virtual keyboard, the list may include the input elements of the set of given input elements and combinations of the input elements of the set of given input elements.

In other implementations of a touchscreen device with a processor for carrying out method 500 where the set of given input elements is not a virtual keyboard, it should be noted that the subset of input elements must still be displayable on the touchscreen of the touchscreen device. Furthermore, as discussed above, the set of given input elements need not be limited to correspond to keys of a keyboard. For example, receiving input indicating a selection of the plurality of virtual keys 320a-e may involve receiving data from an input device other than the touchscreen 102. Examples of input devices other than the touchscreen include an external keyboard, a joystick, a video game controller, or a mouse.

In instances where a plurality of virtual keys includes an input element that does not correspond to a key of a keyboard, a virtual key is still generated to represent the input of the input element. For example, if an input element corresponds to moving a joystick up, where the set of given input elements includes all possible input from a joystick, the subset of input elements would include a virtual key displayable on a touchscreen for receiving input corresponding to moving the joystick up.

When the processor 205 receives input indicating a selection and/or populating of a subset of input elements as described in block 510, the processor 205 may further receive input indicative of a selection of a plurality of locations on the touchscreen 102 where the plurality of virtual keys 320a-e are to be rendered. The input indicative of a selection of a plurality of locations on the touchscreen 102 where the plurality of virtual keys 320a-e are to be rendered can be received through the touchscreen display interface 210 as a result of input at the touchscreen 102. For example, the drag-and-drop selection process described above can indicate the plurality of locations for the plurality of virtual keys 320a-e by using the “drop” location. It will be appreciated that other types of input, such from another input device connected to the input/output interface 220, may receive input indicative of a selection of a plurality of locations. Alternatively, the input indicative of a selection of a plurality of locations may be generated internally by the computer application 230. For example, the computer application 230 may have a pre-determined list of locations for the plurality of virtual keys 320a-e which is automatically applied during method 500. It will be appreciated that the plurality of virtual keys is not limited to exactly five virtual keys and that the subset may include more or less virtual keys depending on the requirements of the computer application 230.

At block 515, processor 205 receive input indicating a size and location of a display area 350 on the touchscreen 102. The input indicating the size and location of the display area 350 on the touchscreen 102 may include data received from the touchscreen display interface 210 as a result of input at the touchscreen. It will be appreciated that other types of input, such as a short cut key (not shown) on the touchscreen device 100 or input from another input device connected to the input/output interface 220, may be used to generate the input indicating the size and location of the display area 350 on the touchscreen 102. Alternatively, the input indicating the size and location of the display area 350 on the touchscreen 102 may be automatically generated internally when executing the computer application 230. It will be further appreciated that the origin of the input indicating the size and location of the display area 350 on the touchscreen 102 may be suitable origin as long as the input triggers the processor 205 to create the display area 350 on the touchscreen 102. Referring back to FIG. 7, showing the present implementation, the display area 350 is smaller than the touchscreen 102. However, it should be appreciated that the display area 350 may also occupy the entire touchscreen 102.

After the input indicating the size and location of the display area 350 on the touchscreen 102 is received, the processor 205 may additionally scale the output from the computer application 230 such that the output is completely rendered within the display area 350. For example, if the output from the computer application 230 is coded to cause the processor 205 to render the application's output over the entire touchscreen 102 when method 500 is not being carried out, the processor 205 may scale the output to fit within the display area 350 when the method is carried out. It will be appreciated that if the processor 205 does not scale the output from the computer application 230, any output intended to be rendered outside of the display area 350 would simply be truncated.

At block 520, the processor 205 renders the plurality of virtual keys 320a-e on the touchscreen 102. In this implementation, the plurality of virtual keys 320a-e are enabled to receive input at the touchscreen 102 corresponding to the application input data for the computer application 230 executed by the processor 205. Again, it will be appreciated that the plurality of virtual keys is not limited to exactly five virtual keys and that the subset may include more or less virtual keys depending on the requirements of the computer application 230.

When the processor 205 renders the plurality of virtual keys 320a-e as described in block 520, the processor 205 may further render the plurality of virtual keys 320a-e outside of the display area 350. By placing the plurality of virtual keys 320a-e outside of the display area 350 (as shown in FIG. 4), the plurality of virtual keys 320a-e will not overlap with any portion of the output rendered from the computer application 230. Therefore, this will prevent obscuring the output rendered from the computer application 230 since the plurality of virtual keys 320a-e remain on the touchscreen 102 indefinitely.

In the present implementation of the touchscreen device 100, method 400 or method 500 provides a means to receive input efficiently from the touchscreen for the computer application 230. In contrast to using the full virtual keyboard 310 during execution of the computer application 230, placing the plurality of virtual keys 320a-e allows for the output from the application to be rendered on the touchscreen 102 with minimal obstruction by the input elements. Although the methods 400 and 500 discussed above may be carried out before the execution of computer application 230, it should be recognized that the methods may be carried out during the execution of the computer application.

While specific implementations of the invention have been described and illustrated, such implementations should be considered illustrative of the invention only and not as limiting the invention as construed in accordance with the accompanying claims.

What is claimed is:

1. A touchscreen device comprising a processor and a touchscreen, the processor operably configured to:
receive input indicative of populating a subset from a set of given input elements, the subset for providing application input data to a computer application, the subset displayable on the touchscreen; and
render the subset on the touchscreen such that the subset is operably configured to receive the application input data.

2. The touchscreen device of claim 1, wherein the processor is operably configured to receive further input indicative of a size and location of a display area, the display area for rendering output from the computer application, wherein the display area is smaller than the touchscreen.

3. The touchscreen device of claim 2, wherein the processor is operably configured to scale the output such that the output is completely rendered within the display area.

4. The touchscreen device of claim 1, wherein the processor is operably configured to receive further input indicative of a selection of a location on the touchscreen such that a selected input element of the subset is rendered at the location.

5. The touchscreen device of claim 1, wherein the processor is operably configured to receive input indicative of populating the subset comprises the processor being operably configured to receive data indicative of a selection from a list.

6. The touchscreen device of claim 1, wherein the set of given input elements comprises virtual keyboard keys rendered at the touchscreen.

7. The touchscreen device of claim 1 wherein the processor is further operably configured to change sizes of the input elements.

8. The touchscreen device of claim 1 wherein the processor is further operably configured to change shapes of the input elements.

9. A method comprising:
receiving, at a touchscreen device including a touchscreen, input indicative of populating a subset from a set of given input elements, the subset for providing application input data to a computer application, the subset displayable on the touchscreen; and
rendering the subset on the touchscreen such that the subset is operably configured to receive the application input data.

10. The method of claim 7, further comprising receiving further input indicative of a size and location of a display area, the display area for rendering output from the computer application, wherein the display area is smaller than the touchscreen.

11. The method of claim 8, further comprising scaling the output such that the output is rendered within the display area.

12. The method of claim 9, wherein rendering the subset of the input elements on the touchscreen comprises rendering the subset of the input elements outside the display area.

13. The method of claim 7, further comprising receiving further input indicative of a selection of a location on the touchscreen such that a selected input element of the subset is rendered at the location.

14. The method of claim 7, wherein the input indicative of populating the subset comprises data indicative of a drag-and-drop selection on the touchscreen.

15. The method of claim 7, wherein receiving the input indicative of populating the subset comprises receiving data indicative of a selection from a list.

16. The method of claim 13, wherein the list comprises input elements of the set of given input elements.

17. The method of claim 14, wherein the list comprises combinations of the input elements of the set of given input elements.

18. The method of claim 7, wherein receiving the input indicative of populating the subset comprises receiving data from an input device other than the touchscreen.

19. The method of claim 7, wherein the set of given input elements comprises virtual keyboard keys rendered at the touchscreen.

20. The method of claim 7, further comprising downloading the computer application into a memory of the touchscreen device through a network connection.

21. The method of claim 7, further comprising executing the computer application on the touchscreen device.

22. The method of claim 7, further comprising changing sizes of the input elements.

23. The method of claim 7, further comprising changing shapes of the input elements.

24. A touchscreen device comprising:
a touchscreen;
a processor;
means for receiving input indicative of populating a subset from a set of given input elements, the subset for providing application input data to a computer application, the subset displayable on the touchscreen; and
means for rendering the subset on the touchscreen such that the subset is operably configured to receive the application input data.

25. A non-transitory computer readable medium encoded with codes, the codes for directing a processor to:
receive input indicative of populating a subset from a set of given input elements, the subset for providing application input data to a computer application, the subset displayable on the touchscreen; and
render the subset on the touchscreen such that the subset is operably configured to receive the application input data.
